(19) United States
(12) Patent Application Publication
(10) Pub. No.: US 2011/0065885 A1
(43) Pub. Date: Mar. 17, 2011

(54) POLYISOCYANURATE ELASTOMER AND A COMPOSITION FOR PRODUCING SAME

(76) Inventors: Karl R. Gust, Clawson, MI (US); Steven Hicks, Brownstown, MI (US)

(21) Appl. No.: 12/557,987

(22) Filed: Sep. 11, 2009

(51) Int. Cl. C08G 18/10

(52) U.S. Cl. 528/85; 528/44

(57) ABSTRACT

A polyisocyanurate elastomer is produced from a composition. The composition comprises an isocyanate-reactive component and an isocyanate component. The isocyanate-reactive component comprises a diol having at least one ether group and further comprises at least one catalyst. The isocyanate-reactive component of the composition is substantially free of polyols. The isocyanate component comprises diphenylmethane diisocyanate. A method of producing the isocyanurate elastomer comprises the steps of providing the isocyanate-reactive component, providing the isocyanate component, mixing the isocyanate-reactive component and the isocyanate component to produce a reaction intermediary, and curing the reaction intermediary.

### FIELD OF THE INVENTION

The present invention generally relates to a polyisocyanurate elastomer and to a composition for producing a polyisocyanurate elastomer having excellent flexural and tensile moduli.

### DESCRIPTION OF THE RELATED ART

Polyisocyanurates are known in the art and may be produced as foams and/or elastomers. Polyisocyanurate foams and elastomers are utilized in a variety of applications due to their versatility and desirable physical properties. One example of an application in which polyisocyanurate foams are utilized is thermal insulation due to excellent thermal stability of polyisocyanurate foams. Polyisocyanurate elastomers are typically utilized in applications which require impact resistance.

Polyisocyanurates are chemically and structurally similar to polyurethanes. For example, polyurethanes are generally produced by reacting a polyol and an isocyanate. In particular, the polyol utilized in producing polyurethanes is typically a polyether polyol, and the isocyanate is not limited to any particular isocyanate. Polyisocyanurates are also produced by reacting a polyol and an isocyanate. However, the polyol utilized in producing polyisocyanurates is typically a polyester polyol, rather than the polyether polyol typically utilized in producing polyurethanes. In addition, the isocyanate utilized in producing polyisocyanurates is generally limited to diphenylmethane diisocyanate (MDI). Polyisocyanurates are known in the art to have greater thermal and chemical stability than polyurethanes.

Although polyisocyanurates have many excellent physical properties, certain drawbacks exist in conventional polyisocyanurate elastomers as well. For example, once the polyol and the isocyanate are mixed to produce a reaction intermediary, the reaction intermediary typically gels instantaneously as it polymerizes, i.e., cures, to produce the conventional polyisocyanurate elastomer. Thus, due to the increasing viscosity of the reaction intermediary, there is a very limited window in which the reaction intermediary may be molded or otherwise manipulated prior to the reaction intermediary curing to produce the conventional polyisocyanurate elastomer.

In addition, conventional polyisocyanurate elastomers have undesirable rigidity, which limits applications in which the conventional polyisocyanurate elastomers may be utilized. For example, conventional polyisocyanurate elastomers generally have a flexural modulus of from 250,000 to 350,000 psi, which makes such conventional polyisocyanurate elastomers undesirable for applications which require excellent rigidity.

Accordingly, there remains an opportunity to provide an improved composition which produces a polyisocyanurate elastomer having excellent physical properties, such as flexural and tensile moduli. There also remains an opportunity to provide an improved method of producing such polyisocyanurate elastomers from compositions.

### SUMMARY OF THE INVENTION AND ADVANTAGES

The present invention provides a composition. The composition comprises an isocyanate-reactive component and an isocyanate component. The isocyanate-reactive component comprises a diol having at least one ether group and further comprises at least one catalyst. The isocyanate-reactive component is substantially free of polyols. The isocyanate component comprises diphenylmethane diisocyanate.

The present invention also provides a polyisocyanurate elastomer and a method of producing the polyisocyanurate elastomer from the composition. The method comprises the steps of providing the isocyanate-reactive component, providing the isocyanate component, and mixing the isocyanate-reactive component and the isocyanate component to produce a reaction intermediary. The method further comprises the step of curing the reaction intermediary for a cure time of at least 5 minutes, thereby producing the polyisocyanurate elastomer.

The composition of the present invention produces a polyisocyanate elastomer having excellent physical properties, including flexural and tensile moduli. As such, the polyisocyanurate elastomer may be utilized in applications in which it is desirable for impact resistance and/or rigidity. In addition, in the method of the present invention, the cure time for curing the reaction intermediary is at least 5 minutes, which provides an extended processing window in which the reaction intermediary may be molded and/or otherwise manipulated prior to producing the polyisocyanurate elastomer.

### DETAILED DESCRIPTION OF THE INVENTION

The present invention provides a composition and a polyisocyanurate elastomer produced from the composition. The present invention also provides a method of producing the polyisocyanurate elastomer from the composition. The polyisocyanurate elastomer of the present invention has excellent physical properties, such as flexural and tensile moduli, as described in greater detail below. Further, the polyisocyanurate elastomer of the present invention has a delayed snap cure, which is also described in greater detail below. The delayed snap cure of the polyisocyanurate elastomer allows for an extended window in which a reaction intermediary produced from the composition may be processed prior to snap curing to produce the polyisocyanurate elastomer. Thus, the polyisocyanurate elastomer is the reaction intermediary after snap curing, and the reaction intermediary is a mixture of the isocyanate-reactive component and the isocyanate component which has not yet cured. Because of the excellent physical properties of the polyisocyanurate elastomer, the polyisocyanurate elastomer of the present invention is particularly suitable for applications in which impact resistance is desirable, such as bullet proof glass. However, the polyisocyanurate elastomer is not limited to such applications; for example, the polyisocyanurate elastomer may also be utilized in fiber reinforced composite articles.

The composition comprises an isocyanate-reactive component. The isocyanate-reactive component is substantially free from polyols. “Substantially free,” as used herein in reference to polyols, is to be interpreted as free from any polyols discretely added to the isocyanate-reactive component. More specifically, the isocyanate-reactive component may comprise polyols in an amount typically less than 2, more typically less than 1, most typically 0 parts by weight based on 100 parts by weight of the isocyanate-reactive component without departing from the definition of substantially free from polyols. In addition, the term “polyol,” as used herein and throughout the art, is defined as any organic compound having at least three hydroxyl groups per molecule. Thus, polyols are distinguished from diols, which have two hydroxyl groups per molecule, i.e., diols are not encompassed by the term “polyol.”

It is to be appreciated that, in traditional polyurethane and/or polyisocyanurate reactions, polyol is utilized and reacted with isocyanate to produce the polyurethane and/or polyisocyanurate. In the case of polyurethanes, the polyol is typically polyether polyol, whereas polyester polyol is typically utilized in producing polyisocyanurates. However, as set forth above, the isocyanate-reactive component of the composition of the present invention is substantially free from polyols. Though the isocyanate-reactive component is substantially free from polyols, the elastomer of the present invention is referred to as a “polyisocyanurate elastomer”. This is attributable to the fact that urethane linkages still exist in the polyisocyanurate elastomer, as described in greater detail below, even though the isocyanate-reactive component is substantially free from polyols.

The isocyanate-reactive component of the composition comprises a diol having at least one ether group. For purposes of clarity, the diol having at least one ether group is hereinafter referred to as “the diol”. It is to be appreciated that the isocyanate-reactive component may comprise a single diol or may comprise a blend of different types of diols. Traditionally, diols are utilized in polyurethane and/or polyisocyanurate reactions as chain extenders by forming urethane linkages between respective isocyanates. The diol of the isocyanate-reactive component may be any diol known in the art having at least one ether group and two hydroxyl groups per molecule.

Typically, the diol of the isocyanate-reactive component has a hydroxyl number of from 830 to 1,810. In addition, the diol of the isocyanate-reactive component typically has a molecular weight of from 60.0 to 150.0 grams per mole. In certain embodiments, the diol is a saturated aliphatic hydrocarbon having from one to seven carbon atoms including those carbon atoms of the at least one ether group. Ether groups are well known in the art and are typically represented by the formula R—O—R, where R can be the same or different. When the diol has from one to seven carbon atoms, the polyisocyanurate elastomer has excellent rigidity, as described in greater detail below. Specific examples of diols having from one to seven carbon atoms and at least one ether group which are suitable for the purposes of the present invention include, but are not limited to diethylene glycol, dipropylene glycol, and combinations thereof. For illustrative purposes only, these diols are depicted in Structures (I) and (II) below in the order in which each respective diol is introduced immediately above.

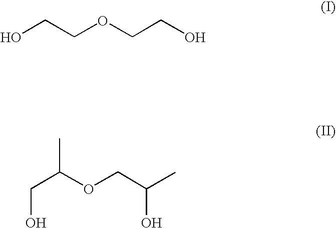

The diol, or blend of diols, is typically present in the isocyanate-reactive component in an amount of from greater than 95, more typically greater than 98, and most typically greater than 99 parts by weight based on 100 parts by weight of the isocyanate-reactive component.

The isocyanate-reactive component further comprises least one catalyst. Typically, the catalyst is selected from the group of carboxylic acid salts, amines, and combinations thereof. In certain embodiments, the catalyst consists essentially of a carboxylic acid salt and an amine. In addition, it is to be appreciated that the catalyst may be disposed in a carrier, such as a diol. Stated differently, when the catalyst is purchased from a supplier, the catalyst is typically disposed in the carrier. It is to be appreciated that the catalyst may be disposed in the carrier without departing from the scope of the catalyst consisting essentially of the carboxylic acid salt and the amine.

Without intending to be limited by theory, it is believed that the at least one ether group of the diol increases a catalytic reactivity of the at least one catalyst. In particular, the at least one ether group has a lone electron pair, which imparts the at least one ether group with Lewis basicity. It is contemplated that the Lewis basicity of the at least one ether group increases the catalytic reactivity of the at least one catalyst which aids in the reaction between the isocyanate component and the isocyanate-reactive component to form the polyisocyanurate elastomer.

One example of a carboxylic acid salt suitable for the purposes of the present invention is potassium acetate, which is depicted in Structure III below for illustrative purposes only.

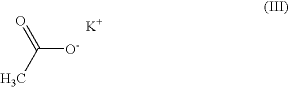

Potassium acetate is commercially available under the tradename Polycat® 46 Catalyst from Air Products and Chemicals, Inc. of Allentown, Pa. When the catalyst is the potassium acetate, the potassium acetate is typically disposed in the carrier. The carrier for the catalyst when the catalyst is the carboxylic acid salt is typically a diol, such as ethylene glycol. It is to be appreciated that when the carrier for the carboxylic acid salt is a diol, the diol can be different than the diol of the isocyanate-reactive component and is not required to have at least one ether group.

One example of an amine suitable for the purposes of the present invention is 1,4-diazabicyclo[2.2.2]octane, which is depicted in Structure IV below for illustrative purposes only.

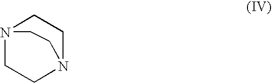

1,4-diazabicyclo[2.2.2]octane is commercially available under the tradename DABCO 33-LV® from Air Products and Chemicals, Inc. of Allentown, Pa. When the catalyst is the 1,4-diazabicyclo[2.2.2]octane, the 1,4-diazabicyclo[2.2.2]octane is typically disposed in a carrier. The carrier for the catalyst when the catalyst is the amine is typically a diol, such as dipropylene glycol. It is to be appreciated that when the carrier for the amine is a diol, the diol can be different than the diol of the isocyanate-reactive component and is not required to have at least one ether group.

The catalyst, or blend of catalysts, is typically present in the isocyanate-reactive component in an amount of from greater than zero to 2, more typically from 0.05 to 1, most typically from 0.1 to 0.6 parts by weight based on 100 parts by weight of the isocyanate-reactive component. In embodiments in which the catalyst consists essentially of the carboxylic acid salt and the amine, each is present in the isocyanate-reactive component in an amount of from greater than zero to 1, more typically from 0.025 to 0.5, most typically from 0.05 to 0.3 parts by weight based on 100 parts by weight of the isocyanate-reactive component, respectively. It is to be appreciated that the ranges of the catalyst present in the isocyanate-reactive component set forth immediately above include any carrier in which the catalyst may be disposed prior to producing the isocyanate-reactive component from the diol and the catalyst. Stated differently, the ranges of the catalyst present in the isocyanate-reactive component set forth above include any carrier in which the catalyst may be disposed when the catalyst is commercially obtained, but the ranges set forth above do not include any diol discretely and/or separately added to the catalyst and/or the isocyanate-reactive component.

In certain embodiments, the isocyanate-reactive component of the composition further comprises an additive. In these embodiments, the isocyanate-reactive component comprises the diol, the catalyst, and the additive. In embodiments in which the isocyanate-reactive component includes the additive, the isocyanate-reactive component may consist essentially of the diol, the catalyst, and the additive. In other embodiments in which the isocyanate-reactive component includes the additive, the isocyanate-reactive component may consist of the diol, the catalyst, and the additive.

Examples of additives suitable for the purposes of the present invention include, but are not limited to, flame retardants, surfactants, mold release agents, antifoams, blocking agents, dyes, pigments, diluents, solvents, specialized functional additives such as antioxidants, ultraviolet stabilizers, biocides, adhesion promoters, antistatic agents, mold release agents, fragrances, water scavengers, such as molecular sieves, and combinations thereof. In certain embodiments, the additive comprises antifoam. When utilized, the additive is typically present in the isocyanate-reactive component of the composition in an amount of from greater than zero to 1.0, typically from greater than zero to 0.3, more typically from greater than zero to 0.2, most typically from greater than zero to 0.15 parts by weight based on 100 parts by weight of the isocyanate-reactive component.

The composition further comprises an isocyanate component. The isocyanate component of the composition is reactive with the isocyanate-reactive component of the composition. Therefore, the isocyanate component and the isocyanate-reactive component are typically separated in the composition until producing the polyisocyanurate elastomer, as described in greater detail below. Stated differently, the composition of the present invention is typically a two component (2K) system. However, it is to be appreciated that the composition may also be a one component (1K) system via an inhibiting agent or other methods known by those skilled in the art. The isocyanate component and the isocyanate-reactive component are typically present in the composition in a ratio of from 600:100 to 2,200:100, more typically from 620:100 to 1,800:100, most typically from 640:100 to 825:100 parts by weight of the isocyanate component to parts by weight of the isocyanate-reactive component such that the composition comprises a stoichiometric excess of the isocyanate component relative to the isocyanate-reactive component. The isocyanate-reactive component is typically referred to in the art as a “resin side,” while the isocyanate component is typically referred to in the art as an “isocyanate side.”

The isocyanate component of the composition comprises diphenylmethane diisocyanate (MDI). In certain embodiments, the isocyanate component may consist essentially of diphenylmethane diisocyanate. In addition, the isocyanate component may consist of diphenylmethane diisocyanate. The MDI may be, for example, 2,2-MDI, 2,4′-MDI, 4,4′-MDI, and combinations thereof. It is to be appreciated that the diphenylmethane diisocyanate may also include an additional functional group. For example, the diphenylmethane diisocyanate may be carbodiimide modified, i.e., the diphenylmethane diisocyanate may include at least one carbodiimide functional group. In addition, the diphenylmethane diisocyanate may be monomeric or oligomeric. For example, the diphenylmethane diisocyanate may be what is referred to in the art as a “prepolymer,” which is typically an oligomer having isocyanate functionality. The diphenylmethane diisocyanate is typically present in the isocyanate component in an amount of from greater than 70, more typically greater than 75, most typically greater than 80, parts by weight based on 100 parts by weight of the isocyanate component. Specific examples of diphenylmethane diisocyanates suitable for the purposes of the present invention include Lupranate® MM103 and Lupranate® MP102, each of which is commercially available from BASF Corporation of Florham Park, N.J.

As set forth above, the present invention also provides a polyisocyanurate elastomer. The polyisocyanurate elastomer comprises the reaction product of the isocyanate-reactive component and the isocyanate component. The polyisocyanurate elastomer has excellent physical properties. For example, the polyisocyanurate elastomer has an excellent flexural modulus, which is known in the art as an indication of a stiffness of the polyisocyanurate elastomer when flexed. In particular, flexural modulus is the ratio of stress to strain of the polyisocyanurate elastomer under a constant force. The polyisocyanurate elastomer typically has a flexural modulus of greater than 300,000, more typically greater than 325,000, most typically greater than 350,000 psi, as measured according to ASTM D638. In addition, the polyisocyanurate elastomer has an excellent tensile modulus, which is known in the art as the ratio of stress to elastic strain in tension. The polyisocyanurate elastomer typically has a tensile modulus of greater than 250,000, more typically greater than 275,000, most typically greater than 300,000 psi, as measured according to ASTM D638.

The present invention also provides a method for producing the polyisocyanurate elastomer. The method comprises the steps of providing the isocyanate-reactive component and providing the isocyanate component. The method further comprises the step of mixing the isocyanate-reactive component and the isocyanate component to produce a reaction intermediary. In certain embodiments, the step of mixing the isocyanate-reactive component and the isocyanate component comprises mixing the isocyanate component and the isocyanate-reactive component in a ratio of from 600:100 to 2,200:100, more typically from 620:100 to 1,800:100, most typically from 640:100 to 825:100 parts by weight of the isocyanate component to parts by weight of the isocyanate-reactive component such that the step of mixing the isocyanate-reactive component and the isocyanate component comprises mixing the isocyanate component in a stoichiometric excess relative to the isocyanate-reactive component.

The step of mixing the isocyanate-reactive component and the isocyanate component to produce the reaction intermediary may be performed by any methods known in the art, such as by mixing the isocyanate-reactive component and the isocyanate component in a vessel, mix metering machine, and/or by mixing the isocyanate-reactive component and the isocyanate component via impingement mixing using a sprayer apparatus. Typically, when adequate mixing is achieved, the reaction intermediary becomes clear, i.e., transparent. In certain embodiments, the polyisocyanurate elastomer is produced in a mold. It these embodiments, it is to be appreciated that the isocyanate-reactive component and the isocyanate component may be mixed to produce the reaction intermediary prior to disposing the reaction intermediary in the mold. For example, the reaction intermediary may be poured into an open mold or the reaction intermediary may be injected into a closed mold. Alternatively, the isocyanate-reactive component and the isocyanate component may be mixed to produce the reaction intermediary within the mold. In certain embodiments, the isocyanate-reactive component and the isocyanate component are mixed to produce the reaction intermediary outside of the mold, and the reaction intermediary is disposed in the mold. It is to be appreciated that the mold may include a mold release agent or a film disposed in a cavity of the mold for removing the polyisocyanurate elastomer from the mold.

The method of the present invention further comprises the step of curing the reaction intermediary to produce the polyisocyanurate elastomer. When the reaction intermediary is disposed in the mold, the polyisocyanurate elastomer generally conforms to a shape of the mold. As set forth above, the polyisocyanurate elastomer has the delayed snap cure. The phrase “delayed snap cure,” as used herein, is to be interpreted as a cure which is delayed, i.e., not instantaneous. However, once initiated, the cure of the reaction intermediary to produce the polyisocyanurate elastomer is instantaneous. In conventional compositions and methods to produce polyisocyanurate elastomers, once the isocyanate-reactive component and the isocyanate component are mixed to produce the reaction intermediary, the reaction intermediary immediately gels, i.e., a viscosity of the reaction intermediary increases as the reaction intermediary polymerizes to produce the polyisocyanurate elastomer. Thus, in conventional methods to produce polyisocyanurate elastomers, the processing window of the reaction intermediary is very limited, or nonexistent. However, in the present invention, a viscosity of the reaction intermediary does not substantially increase and/or gel instantly and, as such, an extended processing window is provided. For example, when the isocyanate-reactive component and the isocyanate component are mixed to produce the reaction intermediary, the reaction intermediary typically has a viscosity of from 400 to 1,000, more typically from 500 to 900, most typically from 600 to 800. The extended processing window allows for polyisocyanurate elastomers to be produced which have increased size due to the fact the reaction intermediary can be poured and/or injected into a large mold without phasing and/or gelling of the reaction intermediary. Phasing and/or gelling of the reaction intermediary make it difficult to dispose the reaction intermediary in the mold and, further, can have adverse effects on physical properties of the polyisocyanurate elastomer produced therefrom.

Once the isocyanate-reactive component and the isocyanate component are mixed, the reaction intermediary typically cures to produce the polyisocyanurate elastomer in a cure time of at least 5 minutes, more typically at least 10 minutes, most typically at least 14 minutes. Stated differently, the processing window of the reaction intermediary is typically at least 5 minutes, more typically at least 10 minutes, most typically at least 14 minutes, before the reaction intermediary snap cures to produce the polyisocyanurate elastomer. In addition, the reaction intermediary cures to produce the polyisocyanurate elastomer at ambient conditions, i.e., in the absence of heat. As such, the times set forth above are the cure times for the polyisocyanurate elastomer at ambient conditions and in the absence of heat, such as heat provided by a curing oven.

The following examples, illustrating the composition, the polyisocyanurate elastomer, and the method of producing the polyisocyanurate elastomer of the present invention, are intended to illustrate and not to limit the invention.

### Examples

A composition comprises an isocyanate-reactive component and an isocyanate component. Each respective composition for the isocyanate-reactive component and the isocyanate component is exemplified below.

### Isocyanate-Reactive Component

The amount and type of each component used to produce isocyanate-reactive components 1 and 2 are indicated in Table 1 below with all values in parts by weight based on 100 parts by weight of each respective isocyanate-reactive component unless otherwise indicated.

TABLE 1

| | Isocyanate-reactive | Isocyanate-reactive |
|---|---|---|
| | Component 1 | Component 2 |
| Diol 1 | 99.40 | — |
| Diol 2 | — | 99.40 |
| Catalyst 1 | 0.25 | 0.25 |
| Catalyst 2 | 0.25 | 0.25 |
| Additive | 0.10 | 0.10 |
| Total: | 100.00 | 100.00 |

Diol 1 is diethylene glycol, which commercially available from many suppliers.

Diol 2 is dipropylene glycol, which commercially available from many suppliers.

Catalyst 1 is potassium acetate in ethylene glycol, commercially available under the tradename Polycat® 46 Catalyst from Air Products and Chemicals, Inc. of Allentown, Pa.

Catalyst 2 is 1,4-diazabicyclo[2.2.2]octane in propylene glycol, commercially available under the tradename Polycat® 46 Catalyst from Air Products and Chemicals, Inc. of Allentown, Pa.

Additive is antifoam A, commercially available from Dow Corning of Midland, Mich.

### Isocyanate Component

Each of the isocyanate-reactive components set forth above is mixed with an isocyanate component to produce a reaction intermediary. The following isocyanate components are utilized:

Isocyanate component 1 is a carbodiimide modified 4,4′-diphenylmethane diisocyanate.

Isocyanate component 2 is a prepolymer based on 4,4′-diphenylmethane diisocyanate.

Isocyanate component 3 is a blend comprising a 50:50 mass ratio of Isocyanate component 1 and Isocyanate component 2.

### Reaction Intermediary

Reaction intermediaries are formed by combining specific isocyanate-reactive components and isocyanate components. The amount and type of each component used to produce the each respective reaction intermediary is indicated in Tables 2 and 3 below with all values in parts by weight based on the total weight of the combined components prior to reaction unless otherwise indicated. More specifically, Table 2 illustrates reaction intermediaries 1-3, which are produced from isocyanate-reactive component 1 and each of isocyanate components 1-3, respectively. Table 3 illustrates reaction intermediaries 4-6, which are produced from the isocyanate-reactive component 2 and each of isocyanate components 1-3, respectively. Notably, each of the reaction intermediaries described below exists prior to curing to form polyisocyanurate elastomers. Stated differently, each of the reaction intermediaries described below have not cured.

TABLE 2

| | Reaction | Reaction | Reaction |
|---|---|---|---|
| | Intermediary 1 | Intermediary 2 | Intermediary 3 |
| Isocyanate-reactive | 100.00 | 100.00 | 100.00 |
| Component 1 | | | |
| Isocyanate | 803.88 | — | — |
| Component 1 | | | |
| Isocyanate | — | 1035.56 | — |
| Component 2 | | | |
| Isocyanate | — | — | 901.69 |
| Component 3 | | | |

TABLE 3

| | Reaction | Reaction | Reaction |
|---|---|---|---|
| | Intermediary 4 | Intermediary 5 | Intermediary 6 |
| Isocyanate-reactive | 100.00 | 100.00 | 100.00 |
| Component 2 | | | |
| Isocyanate | 636.63 | — | — |
| Component 1 | | | |
| Isocyanate | — | 820.11 | — |
| Component 2 | | | |
| Isocyanate | — | — | 714.09 |
| Component 3 | | | |

Each of the reaction intermediaries set forth above in Tables 2 and 3 are evaluated via optical inspection. Reaction intermediaries which were transparent are designated as “good.” Those which were opaque and/or cloudy are designated as “phased.” The results of each of the reaction intermediaries are set forth below in Table 4. Notably, the results of each of the reaction intermediaries described below are relative to the reaction intermediaries prior to curing to form polyisocyanurate elastomers.

TABLE 4

| Reaction Intermediary: | Result: |
|---|---|
| Reaction Intermediary 1 | good |
| Reaction Intermediary 2 | good |
| Reaction Intermediary 3 | good |
| Reaction Intermediary 4 | good |
| Reaction Intermediary 5 | good |
| Reaction Intermediary 6 | good |

As evidenced in Table 4 above, when the isocyanate component is based on diphenylmethane diisocyanate, excellent properties are often obtained from the reaction intermediaries. For example, in reaction intermediaries 1-6, the isocyanate component is carbodiimide modified 4,4′-diphenylmethane diisocyanate, a prepolymer based on 4,4′-diphenylmethane diisocyanate, or a 50:50 blend of the carbodiimide modified 4,4′-diphenylmethane diisocyanate and the prepolymer based on 4,4′-diphenylmethane diisocyanate. In addition, when the diol is diethylene glycol or dipropylene glycol, the reaction intermediary has excellent properties, which is also evidenced by reaction intermediaries 1-6.

Additional isocyanate-reactive components were produced which varied the amount of each of the catalysts and the additive. The amount and type of each component used to produce isocyanate-reactive components 3-5 are indicated in Table 5 below with all values in parts by weight based on 100 parts by weight of the respective isocyanate-reactive component unless otherwise indicated.

TABLE 5

| | | | Isocyanate- |
|---|---|---|---|
| | Isocyanate-reactive | Isocyanate-reactive | reactive |
| | Component 3 | Component 4 | Component 5 |
| Diol 2 | 99.8 | 99.7 | 99.6 |
| Catalyst 1 | 0.05 | 0.10 | 0.15 |
| Catalyst 2 | 0.05 | 0.10 | 0.15 |
| Additive | 0.10 | 0.10 | 0.1 |
| Total: | 100.00 | 100.00 | 100.00 |

Each of isocyanate-reactive components 3-5 is mixed with isocyanate component 3 to produce reaction intermediaries 7-9. The amount and type of each component used to produce the each respective reaction intermediary is indicated in Table 6 below with all values in parts by weight based on the total weight of the combined components prior to reaction unless otherwise indicated.

TABLE 6

| | Reaction | Reaction | Reaction |
|---|---|---|---|
| | Intermediary 7 | Intermediary 8 | Intermediary 9 |
| Isocyanate-reactive | 100.00 | — | — |
| Component 3 | | | |
| Isocyanate-reactive | — | 100.00 | — |
| Component 4 | | | |
| Isocyanate-reactive | — | — | 100.00 |
| Component 5 | | | |
| Isocyanate | 714.09 | 714.09 | 714.09 |
| Component 3 | | | |

Results of reaction intermediaries 7-9 are illustrated in Table 7 below. Notably, each of the reaction intermediaries described below exists prior to curing to form polyisocyanurate elastomers. Stated differently, each of the reaction intermediaries described below have not cured.

TABLE 7

| Reaction Intermediary: | Result: | Time: |
|---|---|---|
| Reaction Intermediary 7 | phased | 17 min |
| Reaction Intermediary 8 | snap cured | 14.5 min |
| Reaction Intermediary 9 | phased | 10.83 min |

As evidenced in Table 7, reaction intermediary 8 snap cured after 14 minutes and 30 seconds. However, reaction intermediaries 7 and 9 phased and did not properly snap cure. Thus, the best results were obtained by utilizing the same amount of the catalyst 1, the catalyst 2, and the additive, as evidenced by reaction intermediary 8 above.

Each of reaction intermediaries 1-6 above are snap cured to form polyisocyanurate elastomers. Physical properties of each of the polyisocyanurate elastomers are calculated and are set forth below in Tables 8 and 9. In particular, each polyisocyanurate elastomer is tested three times for each respective physical property, and the average of the three values is set forth in Tables 8 and 9 for the particular physical property. Table 8 illustrates the average flexural modulus, flexural strength and Shore D hardness for each of the polyisocyanurate elastomers produced from reaction intermediaries 1-6. Table 9 illustrates the average tensile modulus, break elongation and peak stress for each of the polyisocyanurate elastomers produced from reaction intermediaries 1-6.

TABLE 8

| Polyisocyanurate | Flexural | Flexural | Shore D |
|---|---|---|---|
| Elastomer Formed From: | Modulus (psi) | Strength (psi) | Hardness |
| Reaction Intermediary 1 | 416,574.00 | 12,012.97 | 77.33 |
| Reaction Intermediary 2 | 355,478.67 | 12,095.67 | 77.67 |
| Reaction Intermediary 3 | 385,368.67 | 10,625.53 | 73.33 |
| Reaction Intermediary 4 | 421,294.33 | 11,685.63 | 79.67 |
| Reaction Intermediary 5 | 394,017.33 | 11,763.30 | 78.33 |
| Reaction Intermediary 6 | 426,389.67 | 11,125.60 | 77.33 |

TABLE 9

| | | Break | |
|---|---|---|---|
| Polyisocyanurate | Tensile Modulus | Elongation | Peak Stress |
| Elastomer Formed From: | (psi) | (%) | (psi) |
| Reaction Intermediary 1 | 338,450.67 | 3.50 | 8,831.67 |
| Reaction Intermediary 2 | 346,540.00 | 1.83 | 5,610.33 |
| Reaction Intermediary 3 | 323,438.67 | 1.87 | 5,315.33 |
| Reaction Intermediary 4 | 333,294.00 | 2.77 | 7,766.00 |
| Reaction Intermediary 5 | 315,488.00 | 3.53 | 8,925.67 |
| Reaction Intermediary 6 | 323,389.67 | 1.53 | 4,703.33 |

As illustrated by Tables 8 and 9, the polyisocyanurate elastomers produced from reaction intermediaries 1-6 had excellent physical properties, including flexural and tensile moduli.

### Comparative Examples

### Isocyanate-Reactive Component

The amount and type of each component used to produce comparative isocyanate-reactive components 1 and 2 are indicated in Table 10 below with all values in parts by weight based on 100 parts by weight of each respective isocyanate-reactive component unless otherwise indicated.

TABLE 10

| | Comparative | Comparative |
|---|---|---|
| | Isocyanate-reactive | Isocyanate-reactive |
| | Component 1 | Component 2 |
| Diol 3 | 99.40 | — |
| Diol 4 | — | 99.40 |
| Catalyst 1 | 0.25 | 0.25 |
| Catalyst 2 | 0.25 | 0.25 |
| Additive | 0.10 | 0.10 |
| Total: | 100.00 | 100.00 |

Diol 3 is ethylene glycol, which commercially available from many suppliers.

Diol 4 is 1,4-butane diol, which commercially available from many suppliers.

### Isocyanate Component

Each of the isocyanate-reactive components set forth above is mixed with an isocyanate component to produce a reaction intermediary. The following isocyanate components are utilized:

Isocyanate component 4 a polymeric MDI.

Isocyanate component 5 is a prepolymer based on MDI.

### Reaction Intermediary

Reaction intermediaries are formed by combining specific isocyanate-reactive components and isocyanate components. The amount and type of each component used to produce the each respective reaction intermediary is indicated in Tables 11-14 below with all values in parts by weight based on the total weight of the combined components prior to reaction unless otherwise indicated. More specifically, Table 11 illustrates reaction intermediary 10, which is produced from isocyanate-reactive component 1 and isocyanate component 4 Table 12 illustrates reaction intermediary 11, which is produced from isocyanate-reactive component 2 and isocyanate component 4. Table 13 illustrates reaction intermediaries 12-14, which are produced from comparative isocyanate-reactive component 1 and each of isocyanate components 1, 2 and 4, respectively. Table 14 illustrates reaction intermediaries 15-18, which are produced from comparative isocyanate-reactive component 2 and each of isocyanate components 1, 2, 4 and 5, respectively. Notably, each of the reaction intermediaries described below exists prior to curing to form polyisocyanurate elastomers. Stated differently, each of the reaction intermediaries described below have not cured.

TABLE 11

| | Reaction |
|---|---|
| | Intermediary 10 |
| Isocyanate-reactive | 100.00 |
| Component 1 | |
| Isocyanate | 757.65 |
| Component 4 | |

TABLE 12

| | Reaction |
|---|---|
| | Intermediary 11 |
| Isocyanate-reactive | 100.00 |
| Component 2 | |
| Isocyanate | 600.02 |
| Component 4 | |

TABLE 13

| | Reaction | Reaction | Reaction |
|---|---|---|---|
| | Intermediary 12 | Intermediary 13 | Intermediary 14 |
| Comparative | 100.00 | 100.00 | 100.00 |
| Isocyanate- | | | |
| reactive | | | |
| Component 1 | | | |
| Isocyanate | 1372.98 | — | — |
| Component 1 | | | |
| Isocyanate | — | 1768.69 | — |
| Component 2 | | | |
| Isocyanate | — | — | 1294.02 |
| Component 4 | | | |

TABLE 14

| | Reaction | Reaction | Reaction | Reaction |
|---|---|---|---|---|
| | Intermediary | Intermediary | Intermediary | Intermediary |
| | 15 | 16 | 17 | 18 |
| Comparative | 100.00 | 100.00 | 100.00 | 100.00 |
| Isocyanate- | | | | |
| reactive | | | | |
| Component 2 | | | | |
| Isocyanate | 946.91 | — | — | — |
| Component 1 | | | | |
| Isocyanate | — | 1219.82 | — | — |
| Component 2 | | | | |
| Isocyanate | — | — | 892.46 | — |
| Component 4 | | | | |
| Isocyanate | — | — | — | 1265.42 |
| Component 5 | | | | |

Each of the reaction intermediaries set forth above in Tables 11-14 are evaluated via optical inspection. The results of each of the reaction intermediaries are set forth below in Table 15. Notably, the results of each of the reaction intermediaries described below are relative to the reaction intermediaries prior to curing to form polyisocyanurate elastomers.

TABLE 15

| Reaction Intermediary: | Result: |
|---|---|
| Reaction Intermediary 10 | Phases |
| Reaction Intermediary 11 | Phases |
| Reaction Intermediary 12 | Phases |
| Reaction Intermediary 13 | Phases |
| Reaction Intermediary 14 | Foamed |
| Reaction Intermediary 15 | Phases |
| Reaction Intermediary 16 | Phases |
| Reaction Intermediary 17 | Phases |
| Reaction Intermediary 18 | Phases |

As set forth in Table 15 above, none of the reaction intermediaries 10-18 achieved results as desirable as reaction intermediaries 1-6. For example, reaction intermediary 10 was produced from isocyanate-reactive component 1. Notably, isocyanate-reactive component 1 also produced reaction intermediaries 1-3 above, which all had excellent physical properties. Thus, the undesirable physical properties of reaction intermediary 10 are attributable to the isocyanate component of reaction intermediary 10, which is a polymeric MDI. Reaction intermediary 11 was produced from isocyanate-reactive component 2, as were reaction intermediaries 4-6. Reaction intermediaries 4-6 had excellent physical properties, while reaction intermediary 11 had undesirable properties. The isocyanate component utilized to produce reaction intermediary 11, which was polymeric MDI, is once again illustrated to be undesirable for the purposes of the present invention. Reaction intermediaries 12 and 13 were produced from comparative isocyanate-reactive component 1 and isocyanate components 1 and 2, respectively. Reaction intermediaries 1, 2, 4 and 5 were also formed from isocyanate components 1 and 2, yet had excellent physical properties. Thus, the undesirable physical properties of reaction intermediaries 12 and 13 are attributable to comparative isocyanate-reactive component 1, which comprises a diol not having an ether group. Similarly, reaction intermediaries 15 and 16 are produced from comparative isocyanate-reactive component 2 and isocyanate components 1 and 2, respectively. Reaction intermediaries 1, 2, 4 and 5 were also formed from isocyanate components 1 and 2, yet had excellent physical properties. Thus, the undesirable physical properties of reaction intermediaries 15 and 16 are attributable to comparative isocyanate-reactive component 2, which comprises a diol not having an ether group. Thus, diols having an ether group are desirable, while diols not having an ether group are not.

The present invention has been described herein in an illustrative manner, and it is to be understood that the terminology which has been used is intended to be in the nature of words of description rather than of limitation. Obviously, many modifications and variations of the present invention are possible in light of the above teachings. The invention can be practiced otherwise than as specifically described above.

What is claimed is:

1. A polyisocyanurate elastomer having a cure time of at least 5 minutes and comprising the reaction product of:
an isocyanate-reactive component comprising;
a diol having at least one ether group, and
at least one catalyst,
said isocyanate-reactive component being substantially free of polyols; and
an isocyanate component comprising diphenylmethane diisocyanate;

2. A polyisocyanurate elastomer as set forth in claim 1 wherein said cure time is at least 10 minutes.

3. A polyisocyanurate elastomer as set forth in claim 1 wherein said isocyanate component consists essentially of diphenylmethane diisocyanate.

4. A polyisocyanurate elastomer as set forth in claim 3 wherein said isocyanate component consists of diphenylmethane diisocyanate.

5. A polyisocyanurate elastomer as set forth in claim 1 wherein said isocyanate-reactive component consists essentially of said diol having at least one ether group, said at least one catalyst, and optionally an additive present in an amount of from greater than zero to 1 part by weight based on the total weight of said isocyanate-reactive component.

6. A polyisocyanurate elastomer as set forth in claim 5 wherein said isocyanate component consists essentially of diphenylmethane diisocyanate.

7. A polyisocyanurate elastomer as set forth in claim 1 wherein said diol having at least one ether group is selected from the group of diethylene glycol, dipropylene glycol, and combinations thereof.

8. A polyisocyanurate elastomer as set forth in claim 1 wherein said catalyst is selected from the group of amines, carboxylic acid salts, and combinations thereof.

9. A polyisocyanurate elastomer as set forth in claim 1 having a flexural modulus of greater than 300,000 psi, as measured according to ASTM D628 and a tensile modulus of greater than 250,000 psi, as measured according to ASTM D628.

10. A composition comprising:
an isocyanate-reactive component comprising;
a diol having at least one ether group, and
at least one catalyst;
said isocyanate-reactive component being substantially free of polyols; and
an isocyanate component comprising diphenylmethane diisocyanate.

11. A composition as set forth in claim 10 wherein said isocyanate component consists essentially of diphenylmethane diisocyanate.

12. A composition as set forth in claim 11 wherein said isocyanate component consists of diphenylmethane diisocyanate.

13. A composition as set forth in claim 10 wherein said isocyanate-reactive component consists essentially of said diol having at least one ether group, said at least one catalyst, and optionally an additive present in an amount of from greater zero to 1 part by weight based on the total weight of said isocyanate-reactive component.

14. A composition as set forth in claim 13 wherein said isocyanate component consists essentially of diphenylmethane diisocyanate.

15. A composition as set forth in claim 10 wherein said diol having at least one ether group is selected from the group of diethylene glycol, dipropylene glycol, and combinations thereof.

16. A composition as set forth in claim 10 wherein said isocyanate-reactive component and said isocyanate component are present in said composition in a ratio of from 600:100 to 2,200:100 parts by weight of said isocyanate component to parts by weight of said isocyanate-reactive component.

17. A composition as set forth in claim 10 wherein said catalyst is selected from the group of amines, carboxylic acid salts, and combinations thereof.

18. A method for producing a polyisocyanurate elastomer, said method comprising the steps of:
providing an isocyanate-reactive component comprising;
a diol having at least one ether group, and
at least one catalyst,
the isocyanate-reactive component being substantially free of polyols;
providing an isocyanate component comprising diphenylmethane diisocyanate;
mixing the isocyanate-reactive component and the isocyanate component to produce a reaction intermediary; and
curing the reaction intermediary for at least 5 minutes to produce the polyisocyanurate elastomer.

19. A method as set forth in claim 18 wherein the step of curing the reaction intermediary comprises curing the reaction intermediary for at least 10 minutes.

20. A method as set forth in claim 18 wherein the isocyanate component consists essentially of diphenylmethane diisocyanate.

21. A method as set forth in claim 20 wherein the isocyanate component consists of diphenylmethane diisocyanate.

22. A method as set forth in claim 18 wherein the isocyanate-reactive component consists essentially of the diol having at least one ether group, the at least one catalyst, and optionally an additive present in an amount of from greater than zero to 1 part by weight based on the total weight of the isocyanate-reactive component.

23. A method as set forth in claim 22 wherein the isocyanate component consists essentially of diphenylmethane diisocyanate.

24. A method as set forth in claim 18 wherein the diol is selected from the group of diethylene glycol, dipropylene glycol, and combinations thereof.

25. A method as set forth in claim 18 wherein the catalyst is selected from the group of amines, carboxylic acid salts, and combinations thereof.

26. A method as set forth in claim 18 wherein the step of mixing the isocyanate-reactive component and the isocyanate component comprises mixing the isocyanate-reactive component and the isocyanate component in a ratio of from 600:100 to 2,200:100 parts by weight of the isocyanate component to parts by weight of the isocyanate-reactive component.

27. A method as set forth in claim 18 wherein the polyisocyanurate elastomer has a flexural modulus of greater than 300,000 psi, as measured according to ASTM D628, and a tensile modulus of greater than 250,000 psi, as measured according to ASTM D628.
